(19) United States
(12) Patent Application Publication
(10) Pub. No.: US 2012/0324797 A1
(43) Pub. Date: Dec. 27, 2012

(54) SEAL FOR AUTOMOTIVE VEHICLE DOOR

(75) Inventor: Mauro Chiatti, Cirie' (Torino) (IT)

(73) Assignee: COOPER-STANDARD AUTOMOTIVE ITALY S.P.A., Cirie' (Torino) (IT)

(21) Appl. No.: 13/582,670

(22) PCT Filed: Mar. 2, 2011
(86) PCT No.: PCT/IB2011/050885

§ 371 Date: Sep. 4, 2012

(30) Foreign Application Priority Data
Mar. 5, 2010 (IT) TO2010A000169

(51) Int. Cl. B60J 10/08; B29C 47/00; E06B 7/23

(52) U.S. Cl. 49/475.1; 264/176.1

(57) ABSTRACT

The sealing strip (4) comprises an anchoring section (5) to which is connected a tubular sealing section (6) which is intended to interact with the door (D).

The sealing section (6) has a plurality of vent openings (15) adapted to allow the venting towards the outside of the air contained therein when said sealing strip (6) is squeezed by the closing of the door (D). The sealing section also has a cross section adapted to apply to the door (D), when the latter is closed, an increased contact pressure over the entire part of the strip (4) which is to be applied to the upper portion (3a) of said edge (3) of the opening (2) with which the door (D) is associated, and a reduced contact pressure on the parts which are to be applied to the lower (3b) and side portions (3c, 3d) of said edge (3).

The vent openings (15) of the sealing section (6) are provided only in the part of the strip (4) which is to be applied to the aforesaid second lateral portion (3d) of the strip (4).

The present invention relates in a general way to sealing strips for motor vehicles.

More specifically, the invention relates to a sealing strip for the edge of an opening in the bodywork of a motor vehicle which is associated with a door which is swingable between an open and a closed position about an at least approximately vertical axis, wherein the edge of said opening comprises an upper portion and a lower portion connected by a first and a second lateral portion which are, respectively, close to and remote from said axis.

In particular, the invention proposes a strip of the type comprising an anchoring section to which is connected a tubular sealing section intended to interact with the door, the sealing section having a plurality of vent apertures to permit the venting towards the atmosphere of the air contained therein, when said sealing section is squeezed by the closing of the door.

European patent application EP 0 115 750 A1 describes an extruded elastomeric strip of this type in which the tubular sealing section has a wall thickness increased in the parts of the strip intended to be coupled to corner parts of the edge of the corresponding opening of the motor vehicle, in order to resolve sealing problems and rectify the appearance of the sealing section in these corner parts.

Patent application FR 2 862 574-A discloses a similar sealing strip for motor vehicles in which, in order to reduce the transmission to the passenger compartment of low-frequency noise generated by the bodywork, the wall thickness of the sealing section is increased locally only at the ends of the upper portion of the opening in the bodywork, and is reduced in the intermediate part lying between said ends. This solution may give rise to problems of water-, air- and dust-tightness, and may lead to the penetration of external noise into the passenger compartment, in said upper portion of the opening in the bodywork.

European patent application EP 0 407 364 A1 discloses an extruded sealing strip in which the tubular sealing section has a wall thickness which is essentially constant over the whole length of the strip, but with an enlarged cross section in critical parts of the edge of the corresponding opening in the bodywork of the motor vehicle.

Sealing strips of the type described initially have now been found to present a number of problems.

In the first place, in order to provide effective water-, air- and dust-tightness, the sealing section should be made in such a way that its contact pressure against the door is fairly high. However, in order to minimize the force (or energy) required to close the door, the sealing section of the strip should offer the least possible resistance to its deformation by the door when the door is closed.

Thus these two requirements, that is to say the effectiveness of the sealing action and the reduction of the energy required to close the door, conflict with each other.

According to another design requirement, it is desirable for a sealing strip of the type specified above to be capable of providing maximum attenuation of the external noise that tends to penetrate into the motor vehicle.

As regards the sealing action, particularly in relation to water, this requirement is more marked in the front and rear portions of the opening in the bodywork of the motor vehicle, because of the greater exposure of these portions to potential infiltration in static conditions and, especially, in dynamic conditions. This will become clearer if it is considered that, in general, when the vehicle moves at high speed, the air pressure in the passenger compartment tends to be greater than the outside pressure, owing to aerodynamic effects, and therefore the pressure difference tends to move the doors away from their associated sealing strips which are fixed to the corresponding openings in the bodywork of the motor vehicle.

One object of the present invention is to provide an extruded sealing strip which behaves in an optimal way, thus meeting the different requirements, including the aforementioned conflicting requirements, in the various portions of the opening in the bodywork of a motor vehicle.

This and other objects are achieved according to the invention with a sealing strip of the type described above, characterized in that:
the sealing section has a cross section adapted to apply to the door, when the latter is closed, an increased contact pressure over the entire part of the strip which is to be applied to the aforesaid upper portion of the edge of the opening in the vehicle, and a reduced contact pressure in the parts which are to be applied to the lower and lateral portions of said edge, and in that
the aforesaid vent apertures of the sealing section are formed solely in the part of the strip to be applied to the aforesaid second lateral portion of the edge, which is farther from the axis of oscillation of the door.

In one embodiment, the sealing section has an increased wall thickness (towards the outside and/or towards the inside) over the whole upper portion of said edge, and a reduced wall thickness along the lower and lateral portions of this edge.

The increased wall thickness of the sealing section of the strip in the upper portion of the opening in the bodywork of the vehicle substantially improves the effectiveness of the sealing action in relation to water, air and dust in the portion which is known to be more exposed to risks of infiltration. At the same time, this increase in the wall thickness provides better attenuation of the noise which tends to infiltrate into the passenger compartment from the outside. The attenuation of the external noise is further increased by the absence of air vent apertures in the sealing section in the upper portion of the strip, which is closest to the passengers' ears when the vehicle is in use, and is therefore more critical in terms of noise penetration.

The reduction of the wall thickness of the tubular sealing section in the lower and lateral portions of the seal makes it possible to reduce the energy required to close the door. The absence of vent apertures in the lower portion and in the lateral portion of the strip closer to the axis of the swing of the door helps to provide a further reduction in the noise transmitted into the passenger compartment.

Further features and advantages of the invention will be made clear by the following detailed description, provided purely by way of non-limiting example, with reference to the appended drawings, in which:

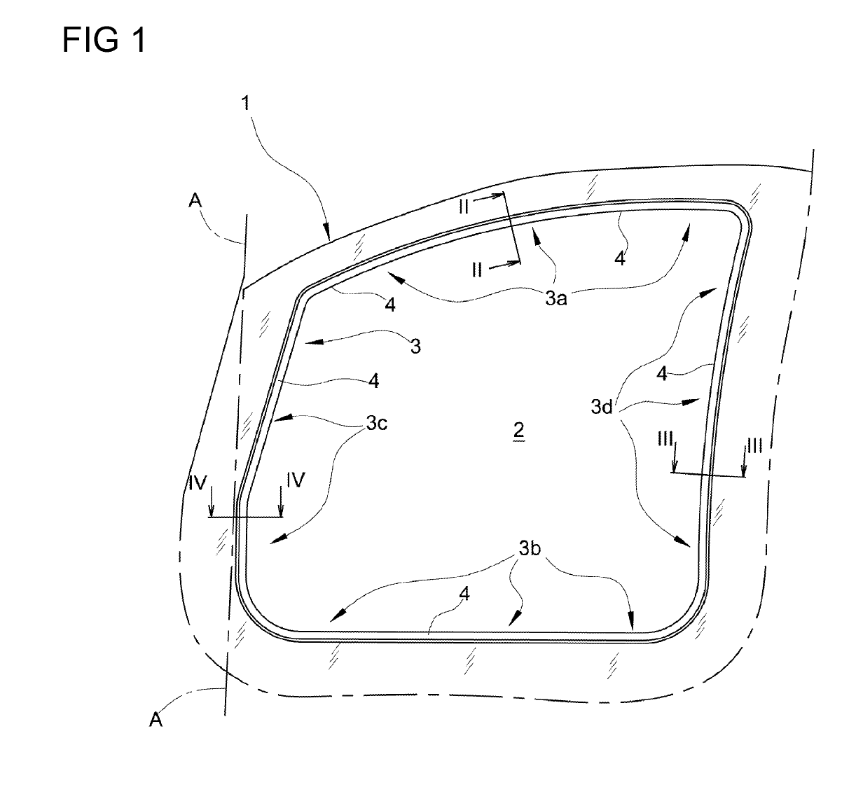

FIG. 1 is a partial side view of the bodywork of a motor vehicle having an opening for a side door, this opening being provided with a sealing strip according to the present invention;

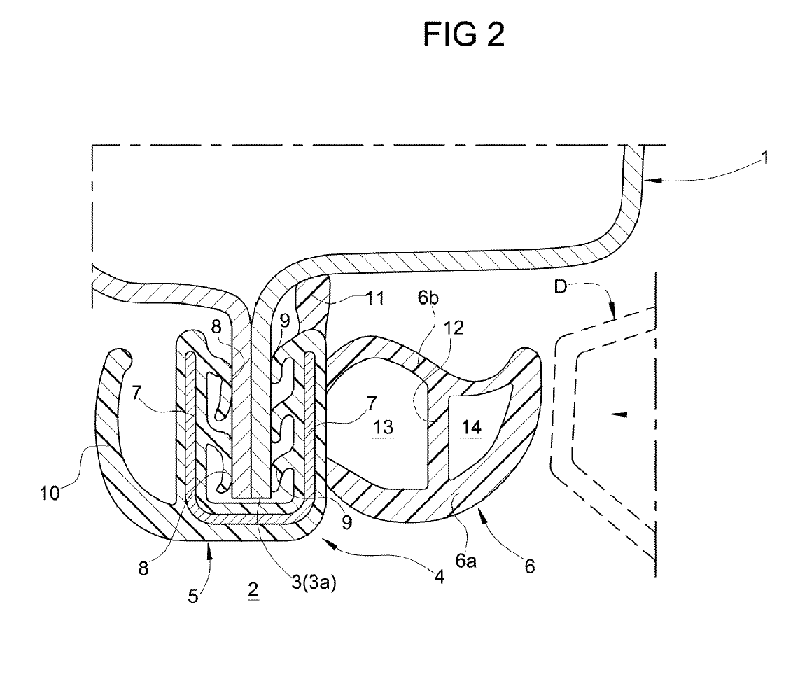

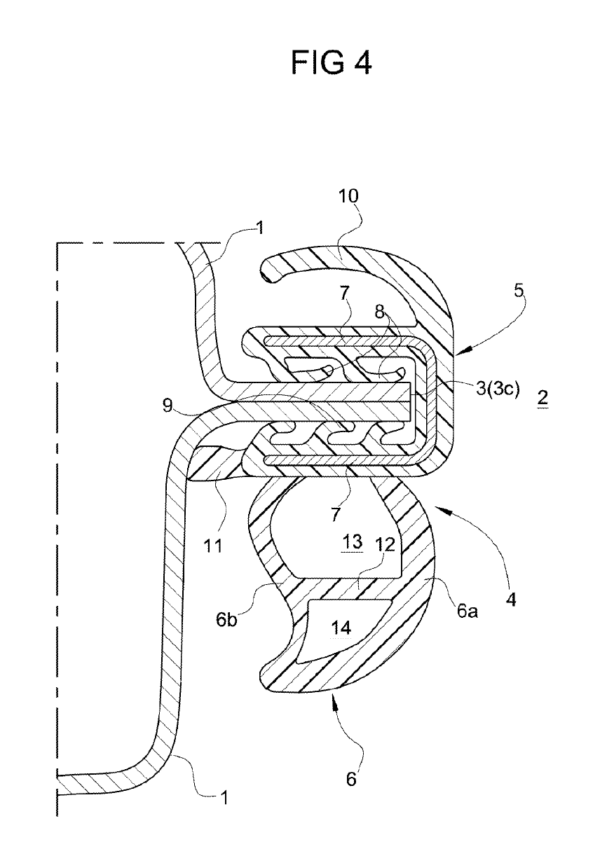

FIGS. 2 to 4 are partial sectional views taken essentially through the lines II-II, III-III and IV-IV respectively in FIG. 1; and

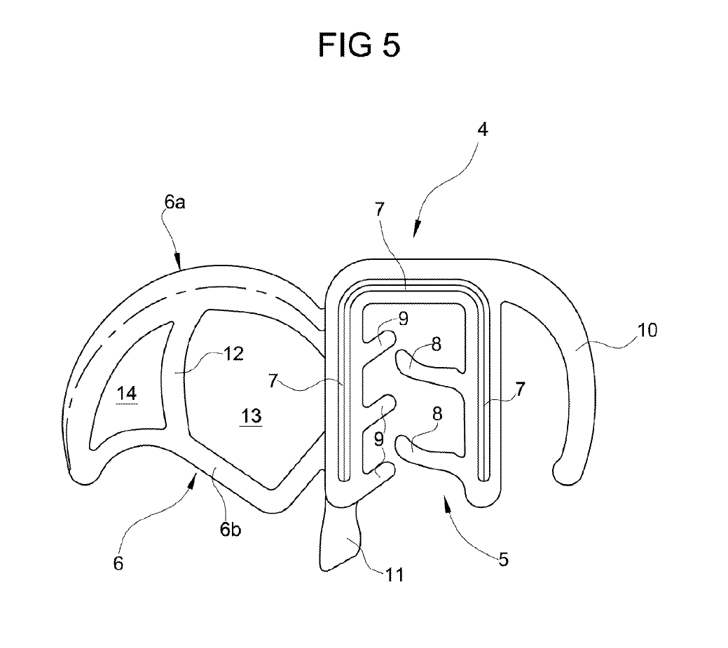

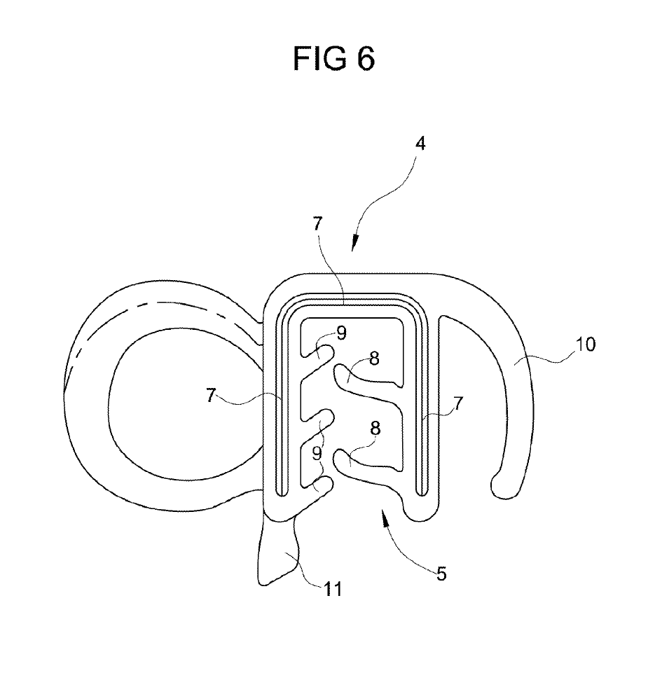

FIGS. 5 and 6 are cross-sectional views of two sealing strips according to the invention, showing the variation of the wall thickness of the tubular sealing section.

With reference to FIG. 1, the number 1 indicates the whole of the bodywork of a motor vehicle, such as a motor car, which has an opening 2. In the illustrated exemplary embodiment, the opening 2 is an opening for a front side door (not shown) of the motor vehicle.

In the following description, it is assumed that the door associated with the opening 2 can be swung in a known way between an open and a closed position, about an at least approximately vertical axis, indicated by A-A in FIG. 1.

The opening 2 has an edge 3 which comprises an upper portion 3a and a lower portion 3b, connected by a first lateral portion 3c and by a second lateral portion 3d, which are, respectively, close to and remote from the axis A-A.

An extruded sealing strip, indicated as a whole by 4, is fixed to the edge 3 of the opening 2.

With reference to FIG. 2 for example, the strip 4 comprises an anchoring section 5, essentially U-shaped or channel shaped, made from an elastomeric material, to which is connected a tubular sealing section 6, made for example from cellular elastomeric material and coextruded with the anchoring section 5.

In the illustrated exemplary embodiment, the anchoring section 5 comprises a core 7, made from metal for example, which is incorporated in the section during extrusion.

The anchoring section 5 contains two opposing arrays of flexible retaining fins 8 and 9, which engage with opposite sides of the flanged edge 3 of the opening 2 in the bodywork of the motor vehicle.

In the illustrated exemplary embodiment, the anchoring section 5 also has a lateral wing 10, facing the inside of the motor vehicle when in use, and a sealing fin 11 (see FIG. 2, for example).

The tubular sealing section 6 in the illustrated exemplary configuration has an intermediate longitudinal partition 12, which divides its internal region into two adjacent chambers 13 and 14 (although the presence of the intermediate partition 12 is not strictly necessary). Additionally, the peripheral wall of the sealing section 6 comprises a curved and externally convex portion of wall or half-wall 6a, which is connected to a portion of wall or half-wall 6b which has a sinuous profile in cross section and is externally convex in its root or proximal part and externally concave in its distal part. However, this configuration is not strictly necessary, since the sealing section 6 can also have a simple rounded shape as shown in FIG. 6.

With reference to FIG. 2, the distal part of the convex curved wall 6a is intended to be engaged by the door D of the motor vehicle, which is partially shown in broken lines in this drawing.

According to the present invention, the sealing section of the strip 4 has an increased thickness (towards the outside and/or towards the inside) in its wall part 6a at least, in the upper portion 3a of the strip only, and a reduced wall thickness in the lower portion 3b and lateral portions 3c, 3d of the strip. A visual comparison of FIGS. 2, 3 and 4 will make this clear.

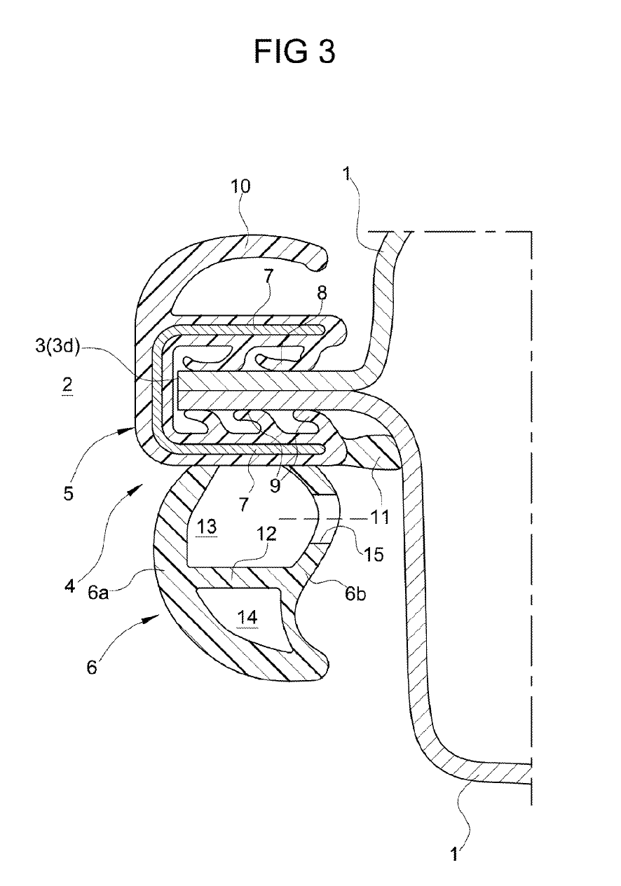

Additionally, and only in the part of the strip 4 applied to the lateral portion 3d of the edge of the opening 2 which is remote from the axis A-A, the tubular sealing section 6 has a plurality of vent holes 15 (FIG. 3) adapted to vent towards the outside the air contained in the chamber 13 of this section when the latter is squeezed by the closing of the door D.

The apertures 15 can be through holes and can be, for example, circular or elongated in the form of slots. These holes or apertures can be made, for example, by mechanical cutting, or by removal of material by a laser beam.

FIG. 5 shows the extent of variation of the wall thickness of the sealing strip 6, particularly in its wall portion 6a: in this drawing, the external contour of the wall 6a shown in solid lines is that which is present next to the upper portion 3a of the edge of the opening 2 of the motor vehicle, while the profile shown below in broken lines indicates the outer contour of the sealing section 6 in the parts of the strip applied to the portions 3b-3d of said opening in the bodywork of the motor vehicle.

The extruded sealing strip according to the invention provides an optimal way of meeting the requirements, including the conflicting requirements, described in the introduction of the present description: the parts of the strip to be applied to the lower portion 3b and lateral portions 3c, 3d of the edge of the opening 2 of the motor vehicle are “lightened” by the reduction of the wall thickness of the sealing section 6. This makes it possible to reduce the energy required to close the door.

On the other hand, the thickening of the wall of the sealing section 6 towards the outside and/or towards the inside, next to the upper portion 3a of the edge 3 of the opening 2, improves the effectiveness of the sealing action and the attenuation of the external noise.

The provision of vent apertures only in the part of the strip 4 to be applied to the lateral portion 3d (remote from the axis A-A of the swing of the door) further limits the level of the noise which can reach the inside of the motor vehicle from the outside.

Naturally, the principle of the invention remaining the same, the forms of embodiment and the details of construction may be varied widely with respect to those described and illustrated, which have been given purely by way of non-limiting example, without thereby departing from the scope of the invention as defined by the attached claims.

In particular, the invention is not limited to a sealing strip for a front side door, but is equally applicable to rear side doors, and more generally to any other type of hinged door or hatch.

1. Sealing strip (4) for the edge (3) of an opening (2) of the bodywork (1) of a motor vehicle, this opening being associated with a door (D) which is swingable between an open and a closed position about an at least approximately vertical axis (A-A), wherein the edge (3) of said opening (2) comprises an upper portion (3a) and a lower portion (3b) which are connected by a first and a second lateral portion (3c, 3d) which are respectively close to and remote from said axis (A-A);
the sealing strip (4) comprising an anchoring section (5) to which is connected a tubular sealing section (6) which is intended to interact with the door (D);
the sealing section (6) having a plurality of vent openings (15) adapted to allow the venting toward the outside of the air contained therein when said sealing strip (6) is squeezed by the closing of the door (D);
the sealing strip (4) being characterized in that
the sealing section has a cross section adapted to apply to the door (D), when the latter is closed, an increased contact pressure over the entire part of the strip (4) which is to be applied to the upper portion (3a) of said edge (3), and a reduced contact pressure on the parts which are to be applied to the lower (3b) and side portions (3c, 3d) of said edge (3), and in that
said vent openings (15) of the sealing section (6) are provided only in that part of the strip (4) which is to be applied to the aforesaid second lateral portion (3d) of the edge (3).

2. Sealing strip according to claim 1, wherein the sealing section (6) has an increased wall thickness over the entire part of the strip (4) which is to be applied to the upper portion (3a) of said edge (3), and a reduced wall thickness in the parts to be applied to the lower (3b) and lateral portions (3c, 3d) of said edge (3).

3. Sealing strip according to claim 1, manufactured as an extruded strip, wherein the variations of the cross section or the wall thickness of the sealing profile (6) are obtained in the extrusion of the strip (4).

4. Sealing strip according to claim 1, wherein the peripheral wall of the sealing section (6) has two half-walls (6a, 6b) which in the condition of use extend from the sealing section (5) towards the door (D), and wherein at least one of said wall portions or half-walls (6a, 6b) has an increased thickness in the part of the strip (4) which is intended to be applied to the aforesaid upper portion (3a) of the edge (3) of the opening (2) of the motor vehicle bodywork.

5. Sealing strip according to claim 4, wherein a part of the wall or half-wall (6a) of the sealing section (6) has an outer curved and convex profile.

6. Sealing strip according to claim 1, wherein the sealing section (6) has an internal longitudinal partition (12) which divides its internal region into two adjacent chambers (13, 14).
